(19) United States
(12) Patent Application Publication
(10) Pub. No.: US 2009/0262722 A1
(43) Pub. Date: Oct. 22, 2009

(54) Method to Calculate Transitive Closure of Multi-Path Directed Network Based on Declarative MetaData

(75) Inventors: Raghupathy Kolandavelu, Phoenix, AZ (US); Timothy J. Felke, Glendale, AZ (US); Kang Zhang, Phoenix, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/106,918

(22) Filed: Apr. 21, 2008

(51) Int. Cl. H04L 12/28

(52) U.S. Cl. 370/351

(57) ABSTRACT

A method for modeling the response of a system to an input signal, wherein metadata describing characteristics of individual system components is combined to identify how signals received at one system component cascade through the system.

### FIELD OF INVENTION

The present application relates to methods of storing and using metadata to identify the propagation of data-driven results through complex systems.

### BACKGROUND

One way of analyzing systems is to identify and associate pieces of source data with pieces of result data that are linked to the source data. When data items are linked based on complex criteria, a tree structure can be used to represent the data and the links between the data. However, a single branch in the tree representing a portion of the result data may be the product of many complex links amongst and between the source data and the result data. The complexity of the links between pieces of data increases the difficulty in calculating, constructing, and using the tree structure.

To perform certain types of data analysis, the user must be able to traverse the tree structure and determine the paths that represent relationships or correlations between one or more pieces of source data and a piece of result data. In very large data sets, calculating these paths is difficult because the relationships and correlations between pieces of source data and pieces of result data may change over time. Further, intermediate nodes on the tree structure may be necessary to reflect aspects of the system and the interaction between pieces of source data and the system. In addition, as the system itself is modified, the criteria for relating pieces of source data to pieces of result data may change. In situations where the criteria are embedded in software, updating the software to reflect changes in the criteria can be time consuming and costly.

### SUMMARY

The present application is directed to software system models and a means of integrating low-level models of individual components of a system into a model of the overall system. A method of constructing a system model utilizes a data-driven approach to combine metadata describing a plurality of characteristics of individual system components into a system model that reflects the behavior of individual system components and the interaction between individual system components.

The resulting system model can be utilized to identify how pieces of source data propagate and cascade through complex systems. The system model can also be used to associate pieces of result data within a complex system with a piece or pieces of source data that trigger the pieces of result data. The described methods enable faster model construction and revision than traditional modeling methods. Where the model is embodied in software that interfaces with a larger system, the described methods permit revisions to be made to the model without requiring substantial changes to other system software.

A first aspect of the present invention provides methods for modeling the response of a system to a signal comprising the steps of acquiring metadata describing a plurality of input characteristics and a plurality of output characteristics of a type of system component and generating a model of the type of system component based on the acquired metadata. The methods also comprise generating a model of an individual system component based on the model of the type of system component and a relationship between the individual system component and the system. A plurality of input signals that the individual system component may receive during the operation of the system are identified and a plurality of output signals generated by the system component in response to receiving any of the plurality of input signals are determined.

A second aspect of the present invention provides methods for modeling the response of a system to a signal comprising acquiring metadata describing a plurality of input characteristics and a plurality of output characteristics of a plurality of types of system components. A model of each type of system component within the plurality of types of system components is generated based on the acquired metadata. The methods also comprise generating a model of a first individual system component based on a model of a type of system component and a relationship between the first individual system component and the system. A plurality of input signals that the first individual system component may receive during the operation of the system is identified, and a plurality of output signals generated by the first system component in response to receiving any of the plurality of input signals is determined. The methods also comprise generating a model of a second individual system component based on a model of a type of system component and a relationship between the second individual system component and the system and identifying a plurality of input signals that the second individual system component may receive during the operation of the system. A plurality of output signals generated by the second individual system component in response to receiving any of the plurality of input signals is also determined. The methods also comprise determining if an output signal generated by the first individual system component may be received as an input signal by the second individual system component. The methods also comprise identifying how a plurality of input signals received by the first system component affects a plurality of output signal generated by the second system component.

These and other aspects, objectives, and advantages of the invention will become further apparent to those of ordinary skill in the art by reading the following detailed description with reference, where appropriate, to the included FIGURES.

### BRIEF DESCRIPTION OF THE FIGURES

FIG. 1 depicts an example chain differentiation in accordance with an embodiment of the invention.

### DETAILED DESCRIPTION OF EXEMPLARY EMBODIMENTS

In many systems, a maintenance subsystem comprising multiple devices such as sensors, computers, and other processors that can be used to monitor the status of various system aspects. These system aspects may include individual components within the system, subsystems, and the overall system. The sensors, computers and other processors used in a maintenance subsystem can be identified generally as line replaceable units (LRUs). Data regarding the condition and operation of system aspects or components, as well as the environment surrounding the system, can be measured and processed by an LRU to determine if a particular aspect or component is functioning properly. When an aberrant condition is identified, an LRU may generate a warning signal that alerts the system operator of the aberrant condition. Upon receipt of a warning signal, the system operator can take corrective action, or otherwise adjust the operation of the system to account for the aberrant condition.

However, in complex systems such as commercial aircraft, several LRUs may monitor a set of the same system aspects. An overlap in monitoring is often intentional to provide a level of redundancy that may improve the reliability of the maintenance subsystem. Multiple LRUs may also be interconnected, where one LRU produces an output signal that is then processed by a second LRU or subsequent additional LRUs. For example, a sensor may send a signal to a signal conditioner for filtering or amplification, which may in turn send a signal to a processor that combines several other signals from a plurality of other LRUs.

In addition to redundancy and interconnectivity of LRUs within the maintenance subsystem, aberrant conditions within one portion of the overall system may trigger other aberrant conditions elsewhere in the system. For example, a blocked or leaky fuel line may cause a decrease in the power output of an engine, which may in turn lead to an unanticipated loss of speed. If one or more LRUs were monitoring the condition of the fuel line, the engine output power, and the speed, each faulty condition would cause a warning signal to be transmitted to the user.

Due to the redundancy of LRUs within the maintenance subsystem, the interconnectivity of LRUs within the maintenance subsystem, and the interrelatedness of aberrant conditions within the overall system, a single aberrant condition in one aspect of the overall system can cause warning signals to be generated by multiple LRUs across multiple aspects of the overall system. As warning signals propagate through the system, other LRUs may generate additional, subsequent warning signals. Consequently, aberrant conditions and their corresponding warning signals can cascade through the maintenance subsystem, causing multiple LRUs throughout the maintenance subsystem to issue warning signals. This cascading effect can result in an “alarm storm,” where the user is bombarded with warning signals indicating faults throughout the system, making it difficult to identify the initial, underlying aberrant condition. Consequently, an alarm storm places the user in a difficult and often dangerous position of taking corrective action based on incomplete information about the initial aberrant condition.

To prevent alarm storms and identify the root cause of the cascaded warning signals, a central maintenance computer can be utilized to receive and process the data from the LRUs within the maintenance subsystem. The central maintenance computer is programmed to perform a cascade removal process, which enables the central maintenance computer to associate a set of cascaded warning signals with the specific aberrant condition or set of conditions that trigger a particular set of cascaded warning signals. The path through which an aberrant condition cascades through the system is called a cascade chain. In order to perform the cascade removal process, the central maintenance computer must be able to identify the cascade chains. Consequently, the cascade chains must be calculated and stored in a manner that is accessible and useable by the central maintenance computer

In accordance with the methods of the invention, metadata pertaining to each type of LRU is used to calculate how aberrant conditions and signals identifying aberrant conditions cascade through the system. This metadata includes the types of input signals that a particular type of LRU is sensitive to and the output signals generated in response to the input signals. The metadata may also include information describing how the type of LRU responds to an aberrant condition and the failure modes of a type of LRU. Additional metadata may be included to further describe the operation of a type of LRU. A template may be used to establish a superset or schema for metadata pertaining to a plurality of LRU types. In implementation where metadata is derived from a number of disparate sources, such as when different manufacturers produce different types of LRUs, the use of a template may permit the metadata to be stored in an organized structure. Further, once stored, the template can be replicated and modified to include metadata pertaining to specific LRU relationships or LRU characteristics, or adapted to store metadata pertaining to new types of LRUs.

After the metadata for each type of LRU is collected, a model of each type of LRU can be generated. The models of each type of LRU provide the basic building blocks for a model of the system. In systems where a particular type of LRU is used in multiple locations throughout the system, the model of the type of LRU can facilitate faster modeling, because models of each occurrence of a particular type of LRU can be made by augmenting the generalized model to include specific information during an occurrence expansion process.

In an occurrence expansion process, a model for each individual LRU is generated and added to the model. In a complex system, several LRUs of the same type may be used in multiple different locations throughout the maintenance subsystem, and may interface with several different types of LRUs. Each individual LRU used in the system is an occurrence of an LRU. Thus, multiple occurrences of a type of LRU may be present in the maintenance subsystem. To account for the differences in location and potential differences in operation of each LRU, the model of a type of LRU is replicated and, if necessary, augmented to reflect each occurrence of an LRU, and the orientation of each particular LRU within the maintenance subsystem. The occurrence expansion process allows each individual LRU model to reflect the position and interconnections that the particular LRU would possess within the overall system. When a model for each occurrence of each LRU is properly located within the maintenance subsystem model, a link calculation process is used to determine how LRUs interact within the system.

Link calculation is preferably a data-driven process. In link calculation, metadata pertaining to the input, output, failure, and other characteristics of each LRU is collected. The metadata describing the input, output, failure, and other characteristics of each LRU is used to determine how an LRU reacts to the input signals it receives and how the signals. Link calculation may be achieved by creating tables of metadata to define half paths. A link can be formed by combining two corresponding half paths. Half paths can be constructed with a plurality of cascade nodes, path definitions, cascade signals, cascade node items, cascade signal items, path occurrences, and path items. Cascade nodes, cascade signals and path definitions are definition level entities. Cascade node items, cascade signal items, path occurrences, and path items are occurrence level entities.

A cascade node is any entity that acts as the starting point of any half path. In general, cascade node entities are available inside an LRU. The metadata describing a cascade node can be stored in a table or other data structure. A cascade signal is any entity that acts as the end point of any half path. In general, cascade signal entities are available outside of an LRU. The metadata describing a cascade node can also be stored in a table or other data structure. A series of path items describe a relationship between a cascade node and a cascade signal. As with cascade nodes and cascade signals, metadata describing a path items can be stored in a table or other data structure. A path definition defines the relationships that are eligible to form a connection between a cascade signal and a cascade node. When the relationships between a cascade signal and a cascade node are identified, path items can be added to the model in accordance with the path definition.

The relationship metadata in a path definition may include identification information regarding a cascade node, identification information regarding a cascade signal, the order or location of the path item compared to other path items, information describing an end of the path, a directionality of the path, and other information further defining a relationship between a cascade node and a cascade signal, a relationship between a cascade node and a path item, a relationship between a path item and a cascade node, and a relationship between a first path item and a plurality of other path items. References to additional tables of metadata can also be stored within cascade nodes, cascade signals, and path items.

Several occurrence level entities may also be used during link calculation. Cascade node items may include a fault report occurrence and a pass thru occurrence. Cascade signal items may include a parameter occurrence, or a non-interface-control-document (non-ICD) occurrence, such as a pneumatic pressure in a hose. Path occurrences may include a monitor occurrence, a failure mode occurrence, a port occurrence, and a parameter occurrence. By using metadata to describe and track the interaction between entities associated with a particular LRU, a link can be defined.

For example, a complete path between a first fault report occurrence and a second fault report occurrence may consist of:

Fault Report—Monitor—Failure Mode—Affects Port—Parameter—Parameter—Monitor—Fault Report

The Fault Reports are cascade node items, and the Parameters are cascade signal items. Since cascade signals mark the end of a half path, the half paths are divided at one of the parameter occurrences. Consequently, the two half paths may take the form of:

Half Path 1: Fault Report—Monitor—Failure Mode—Affects Port—Parameter—Parameter

Half Path 2: Parameter—Monitor—Fault Report

In Half Path 1, Monitor, Failure Mode, and Affects Port form a path definition. Once the half paths are determined, tables of metadata describing the half paths can be populated to identify the occurrence level entities, the interconnections between cascade nodes, path definitions, and cascade signals, and the directionality of the half path. When the cascade node, path definition, and cascade signal are linked in order, a link definition is complete.

Once link calculation is complete for every component of the system, the links can be assembled into chains that represent pathways that data and signals can follow through the system. Links may be combined through a data driven approach, where metadata describing the interconnections between LRUs is compared to a set of rules that govern how connections between links should be represented in the model. As a result of the link calculation process, the response of each link to an input signal is known. Using the modeled response of each link and additional information describing the structure of the system, simulated input signals can be applied to the LRU models. The output signals generated by LRU models in response to an input signal may trigger subsequent responses from

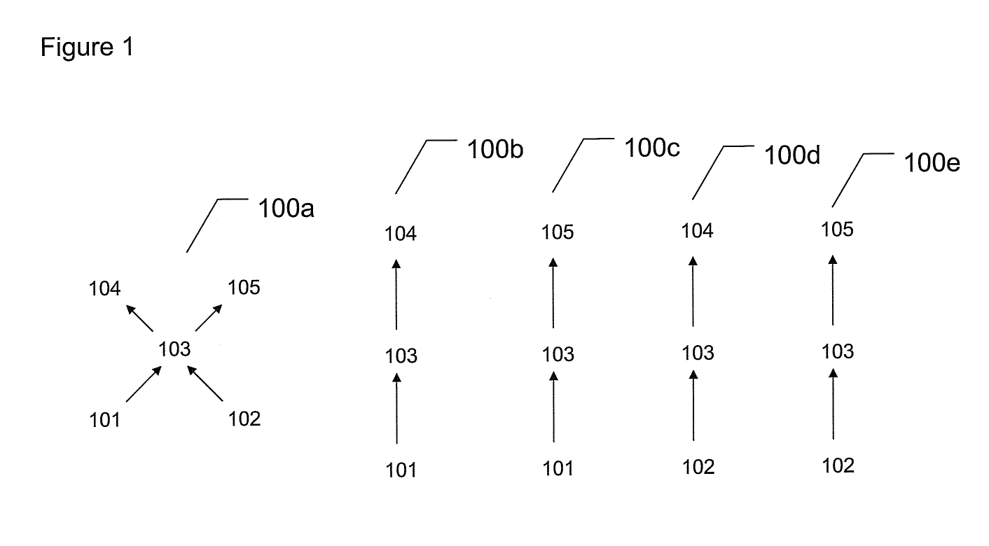

After the chains are calculated, a chain differentiation process may be used to clarify the paths between the beginning of a chain and the end of a chain. In complex systems, chains may include branches and intersections, representing how data and signals cascade through the system. A chain differentiation process creates individual chains for every pathway that a piece of data or signal can cascade through the system. As a result, a plurality of chains is created such that each chain has a single defined beginning and end, and a single, defined path between the beginning and end. Referring to FIG. 1, the chain calculation process may result in a chain that can be represented graphically as shown as a complex chain 100a. In chain 100a, a signal from either of LRUs 101 or 102 can be received by LRU 103. LRU 103 outputs a signal that can be received by either LRU 104 or LRU 105. Chain 100a can be differentiated into four chains 100b-100e. By deconstructing complex chains into individual pathways, chain differentiation permits the propagation of a signal through the system to be isolated and analyzed with particularity.

After chain differentiation has been accomplished, the propagation delay of a piece of data or a signal through each chain is calculated, and the maximum delay time of a signal through the system is determined. When each chain is calculated, and the maximum propagation delay is determined, chain calculation is complete, and the calculated chains can be loaded into the central maintenance computer. Preferably, the cascade chains are stored as loadable diagnostic information (LDI) which can be loaded into the memory of the central maintenance computer, rather than being embedded in the software of the central maintenance computer.

### EXAMPLE IMPLEMENTATION

In an example implementation of the present invention, several tables of metadata are used to identify and describe the components of link. The Cascade_Node table contains the metadata of the entities which are the starting point of any half path. Two half paths may be combined to form a full path, which establishes a link. The Cascade_Node table may take the following form:

| ColumnName | Description |
|---|---|
| EntitySpecId | The Entity Spec from FMMT_Entity_Types. |

In this implementation, FMMT_Entity_Types is a table that contains all the valid entities in a Diagnostic Model Development tool Suite (DMDT), a software program that may be used to build a software model. The FMMT_Entity_Types table also stores information about tables where the information about the entities used in creating the models can be found within a database. A Cascade_Node entity acts as a wrapper entity for any entity in the FMMT_Entity_Types table.

The Cascade_Signal table contains metadata describing entities which are the end point of any half path. A Cascade_Signal entity acts as a wrapper entity for any entity in the FMMT_Entity_Types table. A Cascade_Signal table may take the following form:

| ColumnName | Description |
|---|---|
| EntitySpecId | The Entity Spec from FMMT_Entity_Types. |

A PathItemDefinition table contains the building blocks of the path and stores metadata describing the relationships between cascade nodes and cascade signals. The PathItemDefinition table acts as a wrapper item for any relationship in an FMMT_Relationship_Types table. A FMMT_Relationship_Types table contains the information about the relationships in the model. It stores information about the table names in which the relation information in stored and the source and destination entity details, as well as the foreign key columns where the primary keys of the source and destination tables are stored. The direction indicates whether the data stored in these relationship tables indicates a forward relationship directionality from a source to a destination (F) or a reversed relationship directionality from destination to a source (R).

A PathItemDefinition table may take the following form:

| ColumnName | Description |
|---|---|
| RelSpecId | The Relationship Spec from |
| | FMMT_Relationship_Types. |
| Dir | F/R (Forward Direction/Reverse Direction) |

The CascadeNodeHasPathItemDefinition table contains metadata describing how the path is built from a particular cascade node to cascade signal. A primary key associated with a CascadeNodeHasPathItemDefinition table may also include path order and end-of-path (EOP) metadata. A CascadeNodeHasPathItemDefinition table may take the following form:

| ColumnName | Description |
|---|---|
| SrcItem_Id | The Id from Cascade_Node Table |
| DstItem_Id | The Id from PathItemDefinition Table |
| PathOrder | The Order in which the PathItemDefinition appears |
| | in the path |
| EOP | Marks the end of Path |

The PathItemDefHasCascadeSignal table contains metadata that describes the the relationship between a path item definition and a cascade signal, and may take the following form:

| ColumnName | Description |
|---|---|
| SrcItem_Id | The Id from PathItemDefinition Table |
| DstItem_Id | The Id from Cascade_Signal Table |
| Dir | I/O (I - The Cascade Signal Receives the Data. |
| | O- The Cascade Signal Transmits Data.) Helpful |
| | while forming links. |

In an example model, a full path may extend from a first fault report (FR1) to a second fault report (FR2), and adhere to the following structure:

FR1—Monitor—FM—Affects Port—Parameter1—Parameter2—Monitor—FR2.

The full path may be broken into two half paths at Parameter2, resulting in the following half paths.

Half Path 1: FR1—Monitor—FM—Affects Port—Parameter1—Parameter2

Half Path 2: FR2—Monitor—Parameter2

Based on the half paths, the metadata tables can be populated as follows:

Cascade Node

| EntitySpecID | ID |
|---|---|
| ID from FMMT_Entity_Types for Entity Fault Report Occurrence | 1 |

Cascade Signal

| EntitySpecID | ID |
|---|---|
| ID from FMMT_Entity_Types for Entity Parameter Occurrence | 1 |

PathItemDefinition

| RelSpecId (ID from FMMT_Relationship_Types for) | Dir | ID |
|---|---|---|
| FaultReportOccConsolidatedByMonitorOcc | F | 1 |
| MonitorOccDetectsFailureModeOcc | F | 2 |
| FailureModeOccAffectsPortOcc | F | 3 |
| PortOccTransmitsParameterOccurrence | F | 4 |
| ParameterOccPublishestoParameterOcc | F | 5 |
| MonitorMeasuresParameterOcc | F | 6 |

CascadeNodeHasPathItemDefinition

| SrcItem_Id | DstItem_Id | PathOrder | EOP |
|---|---|---|---|
| 1 | 1 | 1 | 0 |
| 1 | 2 | 2 | 0 |
| 1 | 3 | 3 | 0 |
| 1 | 4 | 4 | 0 |
| 1 | 5 | 5 | 1 |
| 1 | 6 | 2 | 1 |

PathItemDefHasCascadeSignal

| SrcItem_id | DstItem_Id | Dir |
|---|---|---|
| 5 | 1 | I |
| 6 | 1 | O |

A similar set of tables may contain additional metadata that may be used to populate the tables which store the information about the Entity types. The Cascade_Node_Item table contains the entities which are the starting point of any half path.

| ColumnName | Description |
|---|---|
| EntitySpecId | The Entity Spec from FMMT_Entity_Types. |
| EntityId | The Primary Key of the Entity Type |
| Id | The Primary key of the Cascade Node Item. |
| | This would be used as a reference key for |
| | other tables that references cascade node item |

A Cascade_Signal table contains the entities which are the end point of any half path.

| ColumnName | Description |
|---|---|
| EntitySpecId | The Entity Spec from FMMT_Entity_Types. |
| EntityId | The Primary Key of the Entity Type |
| Id | The Primary key of the Cascade Signal Item. |
| | This would be used as a reference key for other |
| | tables that references cascade signal item |

A PathItem table contains the building blocks of the path. The relationship data as specified in a PathItemDefinition table is stored in a PathItem table, and may include information describing the directionality of the building blocks.

| ColumnName | Description |
|---|---|
| RelSpecId | The Relationship Spec from |
| | FMMT_Relationship_Types. |
| Dir | F/R (Forward Direction/Reverse Direction) |
| SrcId | Source Reference/Foreign Key for the relation |
| DstId | Destination Reference/Foreign Key for the |
| | relation |
| Id | The primary key for the pathitem table. This |
| | would be used as a reference key for other |
| | tables that references pathitem item. |

Various arrangements and embodiments in accordance with the present invention have been described herein. It will be appreciated, however, that those skilled in the art will understand that changes and modifications may be made to these arrangements and embodiments as well as combination of the various embodiments without departing from the true scope and spirit of the invention, which is defined by the following claims.

1. A method for modeling the response of a system to a signal comprising the steps of:
acquiring metadata describing a plurality of input characteristics and a plurality of output characteristics of a type of system component;
generating a model of the type of system component based on the acquired metadata;
generating a model of an individual system component based on the model of the type of system component and a relationship between the individual system component and the system;
identifying a plurality of input signals that the individual system component may receive during the operation of the system; and
determining a plurality of output signals generated by the system component in response to receiving any of the plurality of input signals.

2. The method of claim 1 wherein acquiring metadata describing a plurality of input characteristics and a plurality of output characteristics comprises storing metadata in a template.

3. The method of claim 2 further comprising calculating a time required by an individual system component to generate an output signal in response to receiving an input signal.

4. A computer program implementing the method of claim 3.

5. A method for modeling a response of a system to a signal comprising:
acquiring metadata describing a plurality of input characteristics and a plurality of output characteristics of a plurality of types of system components;
generating a model of each type of system component within the plurality of types of system components based on the acquired metadata;
generating a model of a first individual system component based on a model of a type of system component and a relationship between the first individual system component and the system;
identifying a plurality of input signals that the first individual system component may receive during the operation of the system;
determining a plurality of output signals generated by the first system component in response to receiving any of the plurality of input signals.
generating a model of a second individual system component based on a model of a type of system component and a relationship between the second individual system component and the system;
identifying a plurality of input signals that the second individual system component may receive during the operation of the system;
determining a plurality of output signals generated by the second individual system component in response to receiving any of the plurality of input signals;
determining if an output signal generated by the first individual system component may be received as an input signal by the second individual system component;
identifying how a plurality of input signals received by the first individual system component affects a plurality of output signals generated by the second individual system component; and
storing a file on a machine readable medium, wherein the file comprises information correlating the plurality of output signals generated by the second individual system component to the plurality of input signals received by the first individual system component.

6. The method of claim 5 wherein acquiring metadata describing a plurality of input characteristics and a plurality of output characteristics comprises storing metadata in a template.

7. The method of claim 6 wherein generating a model of a first individual system component based on a model of a type of system component and a relationship between the first individual system component and the system comprises acquiring additional metadata describing a location of the first individual system component in relation to a structure of the system.

8. The methods of claims 7 further comprising acquiring additional metadata describing a plurality of functions performed by the first individual system component.

9. The method of claim 8 wherein identifying a plurality of input signals that the first individual system component may receive during operation of the system comprises acquiring and storing additional metadata regarding the plurality of input signals.

10. The methods of claim 9 wherein determining if an output signal generated by the first individual system component may be received as an input signal by the second individual system component comprises applying a plurality of rules based on metadata describing a plurality of design elements of the system.

11. The methods of claim 10 wherein identifying how a plurality of input signals received by the first system component affects a plurality output signal generated by the second system component comprises correlating an output signal generated by the second individual system component in response to each particular input signal within the plurality of input signals being received by the first individual system component.

12. The methods of claim 11 further comprising calculating a time required for the second individual system component to generate an output signal in response to the first system component receiving an input signal.

13. The method of claim 7 wherein generating a model of a second individual system component based on a model of a type of system component and a relationship between the second individual system component and the system comprises acquiring additional metadata describing a location of the second individual system component in relation to the structure of the system.

14. The method of claim 5 wherein identifying how a plurality of input signals received by the first individual system component affects a plurality of output signals generated by the second individual system components comprises using the metadata describing a plurality of input characteristics and a plurality of output characteristics to calculate a plurality of half links based on metadata describing the first system component.

15. The method of claim 14 further comprising combining the plurality of half links into a plurality of full links;

16. The method of claim 15 further comprising combining the plurality of full links into chains.

17. The method of claim 5 wherein identifying how a plurality of input signals received by the first individual system component affects a plurality of output signals generated by the second individual system component further comprises correlating an individual output signal within the plurality of output signals generated by the second individual system component to an individual input signal within the plurality of input signals received by the first individual system component.

18. A computer program implementing the method of claim 5.

19. A computer program implementing the method of claim 12.

20. A computer program implementing the method of claim 17.
